(19) United States
(12) Patent Application Publication
(10) Pub. No.: US 2026/0054838 A1
(43) Pub. Date: Feb. 26, 2026

(54) VIP FRONT ROW BUSINESS CLASS MONUMENT

(71) Applicant: B/E Aerospace, Inc., Winston-Salem, NC (US)

(72) Inventors: Oscar Ruiz Lara, Kirkland, WA (US); Daniel N. Moe, Mukilteo, WA (US); Nathaniel Hamontree, Fort Worth, TX (US); Travis J. Vaninetti, Bothell, WA (US); Jeremy F. Malecha, Pfafftown, NC (US); Zane M. Yates, Clemmons, NC (US); Tyler Nikitas, Johns Island, SC (US)

(21) Appl. No.: 18/811,388

(22) Filed: Aug. 21, 2024

(51) Int. Cl. B64D 11/06; B64D 11/00

(52) U.S. Cl. CPC B64D 11/0602; B64D 11/0015; B64D 11/0606; B64D 11/062; B64D 11/0636; B64D 11/0638

(57) ABSTRACT

A monument for inclusion in a business class cabin defines an unobstructed foot well and entertainment features disposed on a surface opposite the primary seat. The monument defines a full width ottoman. The full width ottoman may be configured to support a bassinet. The full width ottoman may include a seatbelt attachment point such that a second passenger may face the primary seat while buckled. The monument may also include a stowable tray table disposed for use by the second passenger.

### BACKGROUND

First-class seating for long-haul flights requires significant space within the cabin as compared to business class seating. Removing first-class seating to increase overall capacity creates a gap in the airline's offering. There is a need for differentiated first-class seating that does not adversely impact overall capacity.

### SUMMARY

In one aspect, embodiments of the inventive concepts disclosed herein are directed to a monument for inclusion in a business class cabin. The monument defines an unobstructed foot well and entertainment features disposed on a surface opposite the primary seat.

In a further aspect, the monument defines a full width ottoman. The full width ottoman may be configured to support a bassinet.

In a further aspect, the full width ottoman may include a seatbelt attachment point such that a second passenger may face the primary seat while buckled. The monument may also include a stowable tray table disposed for use by the second passenger.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows top views of passenger cabins according to an exemplary embodiment;

FIG. 2 shows a top view of a passenger seating unit according to an exemplary embodiment;

FIG. 3 shows a top view of a passenger seating unit according to an exemplary embodiment;

FIG. 4 shows a perspective view of a passenger seating unit according to an exemplary embodiment;

FIG. 5 shows a perspective view of a passenger seating unit according to an exemplary embodiment;

FIG. 6 shows a perspective view of a passenger seating unit according to an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a monument for inclusion in a business class cabin. The monument defines an unobstructed foot well and entertainment features disposed on a surface opposite the primary seat. The monument defines a full width ottoman. The full width ottoman may be configured to support a bassinet. The full width ottoman may include a seatbelt attachment point such that a second passenger may face the primary seat while buckled. The monument may also include a stowable tray table disposed for use by the second passenger.

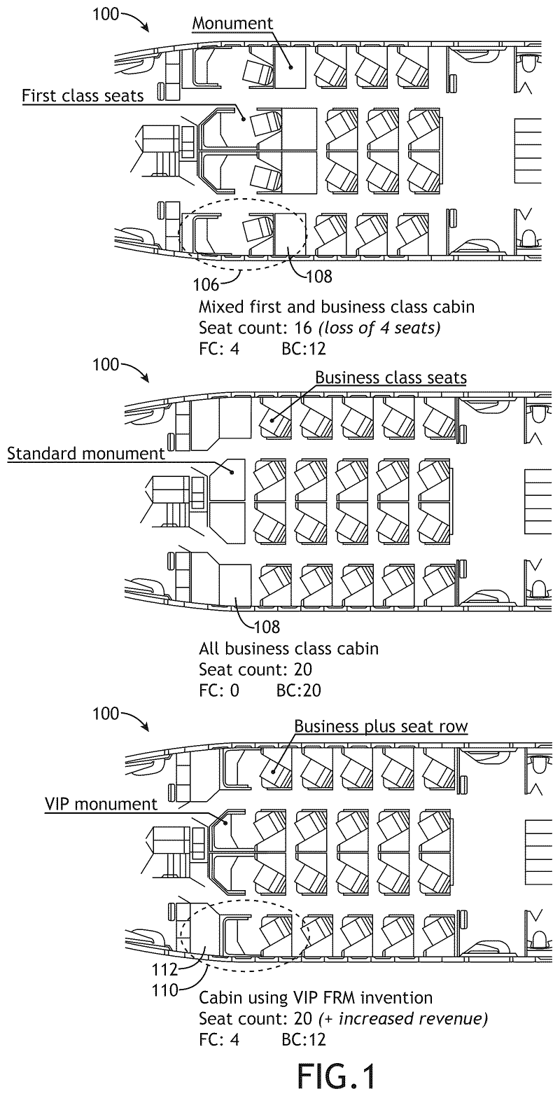

Referring to FIG. 1, top views of passenger cabins according to an exemplary embodiment are shown. Traditional cabins 100 divided into first class and business class include first class seating units 106 and business class seating units separated by a monument 108. The monument 108 generally includes entertainment features for the corresponding business class seating unit and defines a covered foot well. Most front row monuments 108 replicate the living space of regular business class seats, taking space from front row passengers to equalize the experience and provide extra storage for the crew.

In a business class only cabin 102, the business class seating units occupy the entire cabin and corresponding monuments 108 occupy the space closest the forward bulkhead to provide entertainment features and foot space. The business class only cabin 102 provides increased passenger capacity but no differentiation for a higher quality experience.

In at least one embodiment, a mixed class cabin 104 according to at least one embodiment includes business class seating units and at least one VIP seating unit 110 including a monument 112 as described more fully herein. The monument 112 defines an uncovered foot well/ottoman and includes entertainment features in a space generally corresponding to existing monuments 110 while providing a differentiated experience without reducing overall passenger capacity.

The business class cabin may be the best alternative for the mixed class cabin 104 due to its location in the plane and distance from the door. Due to layout optimization, the living space in business class seats is much smaller than in comparable first-class seats as most business class seats have an overlap under the console of the seat in front of them where a passenger's feet go when in a bed configuration. Such configuration results in a greatly reduced living space. This overlap is one of the main defining differences between business and first-class seating and has a significant impact in perceived living space. The front-row seats are in a unique position to avoid that overlap with the application of a monument according to the present disclosure, creating a first-class seating experience with an increased living space.

The monument installed in front of the first row of business class seats within a cabin section allocates the space in front of the seat to the passenger instead of cabin storage, considerably increasing the space available to the passenger.

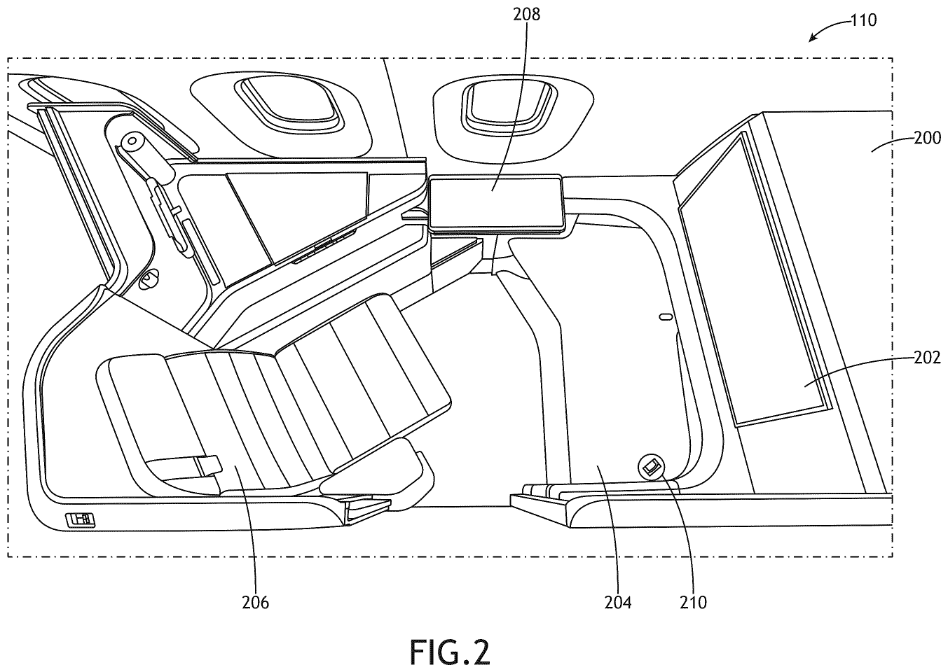

Referring to FIG. 2, a top view of a passenger seating unit 110 according to an exemplary embodiment is shown. The passenger seating unit 110 may include a passenger seat 206 which may generally correspond to passenger seats in a business class cabin, and a monument 200 that may be disposed proximal to a forward bulkhead in a business class cabin.

The monument 200 houses entertainment features 202 including a monitor that may be larger than other monitors in the business class cabin. The larger monitor is desirable to provide a comparable viewing experience as compared to other seating units in the business class cabin as the monument 200 defines an open foot well with an ottoman 204, and the monitor is disposed further form the passenger seat 206.

In at least one embodiment, the ottoman 204 includes seat belt elements 210 to provide facilities for a second passenger to sit on the ottoman 204 facing the passenger seat 206. In at least one embodiment, the monument 200 is configured and disposed to accommodate a passenger tray table 208.

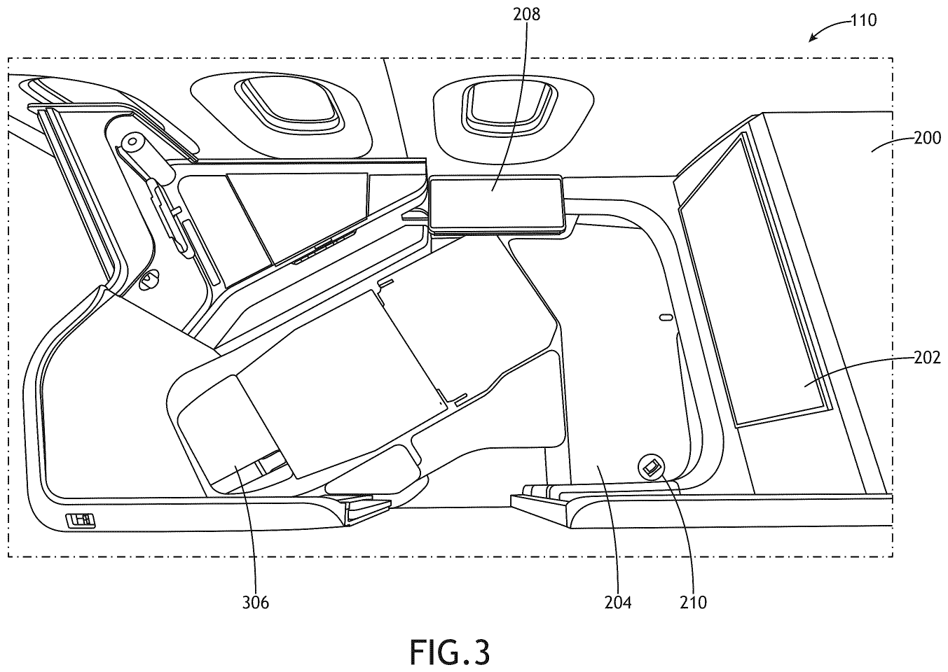

Referring to FIG. 3, a top view of a passenger seating unit 110 according to an exemplary embodiment is shown. When the passenger seat 306 is in a fully reclined configuration, the ottoman 204 is configured to engage the reclined passenger seat 306. The reclined passenger seat 306 and ottoman 204 define a generally continuous, unobstructed sleeping surface.

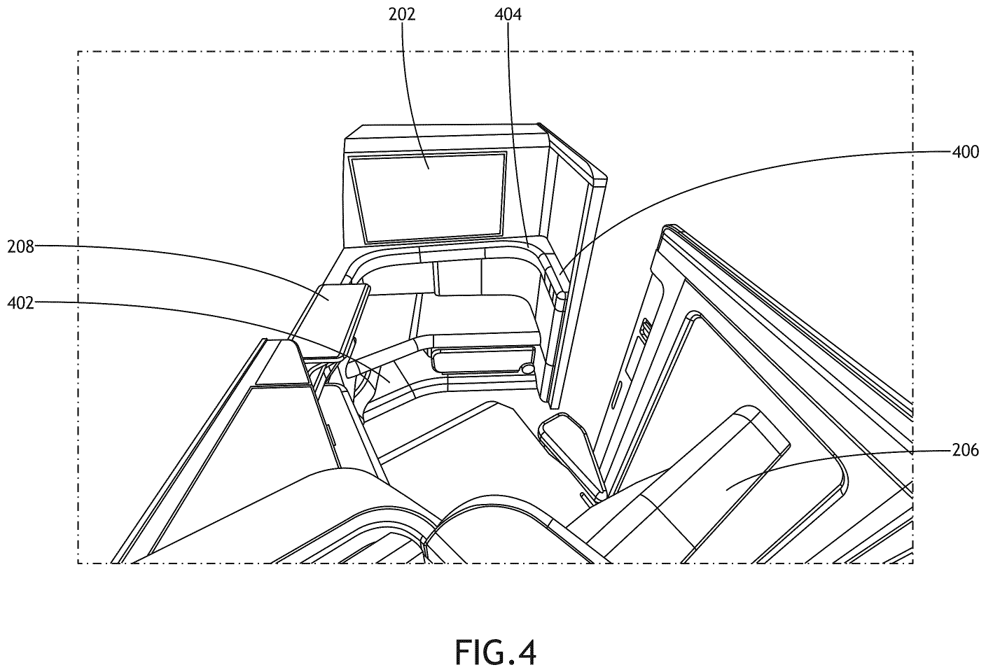

Referring to FIG. 4, a perspective view of a passenger seating unit according to an exemplary embodiment is shown. The passenger seating unit includes a passenger seat 206 and a corresponding monument including entertainment features 202. The monument defines an open foot well and includes an ottoman; the ottoman may define a stowage space 402 for carry-on bags. In at least one embodiment, the ottoman is configured to engage the passenger seat 206 when the passenger seat 206 is in a reclined configuration to form an unobstructed sleeping surface.

The ottoman allows passengers to stow their carry-on luggage within the suite by placing it under the ottoman, keeping their contents safe and easily, privately accessible throughout the flight. Existing business class products do not have in-suite carry-on stowage, requiring passengers to lift baggage that can be heavy and place them in the overhead bins.

In at least one embodiment, the monument includes a cushioned backrest portion 404 disposed along a perimeter portion, opposite the passenger seat 206, corresponding to the ottoman. In at least one embodiment, the monument may include a stowable tray table 400. The stowable tray table 400 may be disposed proximal to the ottoman such that a second passenger may be seated on the ottoman and utilize the stowable tray table 400. The stowable tray table 400 may be stored between the ottoman and the aisle side privacy wall to enable face-to-face dining when the second passenger sits on the ottoman during meal service.

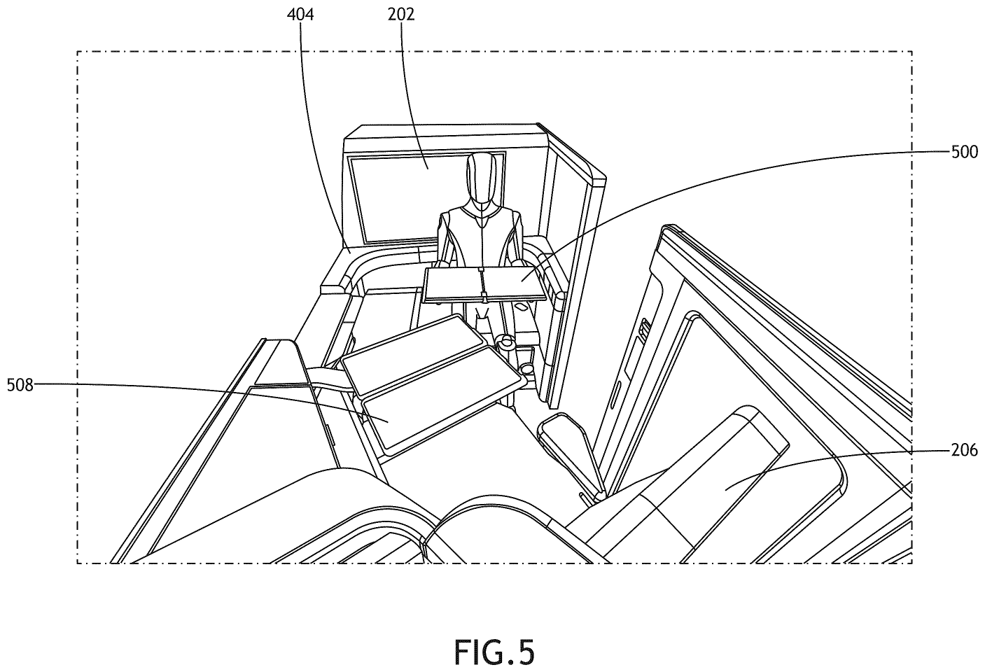

Referring to FIG. 5, a perspective view of a passenger seating unit according to an exemplary embodiment is shown. In at least one embodiment, the passenger seating unit includes a monument with an unobstructed ottoman. A second passenger may utilize the ottoman to sit facing the passenger seat 206. A deployed stowable tray table 500 is disposed for use by the second passenger when seated on the ottoman. A corresponding passenger tray table 508 is disposed for use by the passenger in the passenger seat 206 such that the passenger tray table 508 and deployed stowable tray table 500 do not interfere with each other.

In at least one embodiment, a cushioned backrest portion 404 is disposed for use by the second passenger. The ottoman may include seat belt features for the second passenger when seated facing the passenger seat 206. The cushioned backrest portion 404 around the ottoman provides support for the second passenger's backs when using the ottoman as a seat.

Existing business class seats do not typically have enough space for more than one person. Embodiments of the present disclosure enable different seating arrangements with two passengers flying together; families or couples having a private space inside a single suite; and two passengers traveling face-to-face.

Embodiments enable airlines to offer a limited number of first-class experiences within business class cabins without the loss of passenger capacity and the added costs a true first-class product would require. Passengers flying in passenger seating units according to exemplary embodiments may experience a larger living space than the business class seats behind them and have an open footwell that allows them to move freely when sleeping or relaxing. The improvement in living space allows installing a larger monitor 202 for enhanced entertainment offerings.

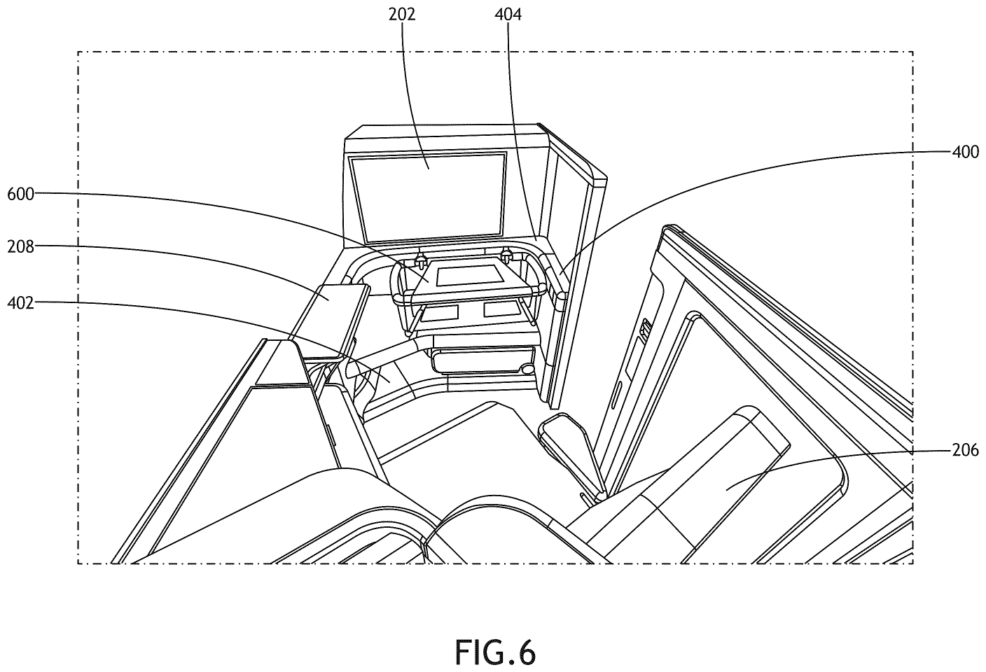

Referring to FIG. 6, a perspective view of a passenger seating unit according to an exemplary embodiment is shown. In at least one embodiment, the passenger seating unit includes a monument with an unobstructed ottoman. The ottoman may be configured to receive a bassinet. Furthermore, the ottoman may include features to secure the bassinet. For example, seat belts may be disposed to engage portions of the bassinet 600 and secure it to the ottoman.

The bassinet fittings also allow parents or guardians to care for their babies at a location that is private and within easy reach while still having enough space to lay in a fully reclined passenger seat 206 and sleep during flight.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

1. A business class monument comprising:
a privacy wall;
a monitor; and
an ottoman,
wherein:
the monument is configured to be disposed in front of a first-row business class passenger seat and is structurally separate from the passenger seat;
the privacy wall and ottoman define an open, unobstructed footwell extending between the passenger seat and the monument without enclosing walls;
the ottoman is disposed opposite a passenger seat; and
the monitor is disposed in a wall of the monument opposite the passenger seat;
the ottoman is configured to support a second passenger seated on the ottoman facing the passenger seat;
the ottoman includes integrated seatbelt features for restraining the second passenger while seated on the ottoman; and
the ottoman includes attachment features configured to secure a bassinet to the ottoman.

2. The business class monument of claim 1, wherein the ottoman defines a stowage space beneath a foot support surface.

3. (canceled)

4. The business class monument of claim 1, further comprising a stowable tray table disposed for use by the second passenger when the second passenger uses the ottoman as a seat.

5. (canceled)

6. The business class monument of claim 1, further comprising a cushioned backrest portion disposed along at least one internal wall of the monument, proximal to the ottoman.

7. The business class monument of claim 1, wherein the ottoman is configured to abut an edge of the passenger seat when the passenger seat is in a reclined configuration.

8. A passenger seating unit comprising:
a passenger seat; and
a monument comprising:
a privacy wall;
a monitor; and
an ottoman,
wherein:
the monument is configured to be disposed in front of a first-row business class passenger seat and is structurally separate from the passenger seat;
the privacy wall and ottoman define an open, unobstructed footwell extending between the passenger seat and the monument without enclosing walls;
the ottoman is disposed opposite a passenger seat; and
the monitor is disposed in a wall of the monument opposite the passenger seat;
the ottoman is configured to support a second passenger seated on the ottoman facing the passenger seat;
the ottoman includes integrated seatbelt features for restraining the second passenger while seated on the ottoman; and
the ottoman includes attachment features configured to secure a bassinet to the ottoman.

9. The passenger seating unit of claim 8, wherein the ottoman defines a stowage space beneath a foot support surface.

10. (canceled)

11. The passenger seating unit of claim 8, further comprising a stowable tray table disposed for use by the second passenger when the second passenger uses the ottoman as a seat.

12. (canceled)

13. The passenger seating unit of claim 8, further comprising a cushioned backrest portion disposed along at least one internal wall of the monument, proximal to the ottoman.

14. The passenger seating unit of claim 8, wherein the ottoman is configured to abut an edge of the passenger seat when the passenger seat is in a reclined configuration.

15. An aircraft comprising:
at least one passenger seat; and
a corresponding monument comprising:
a privacy wall;
a monitor; and
an ottoman,
wherein:
the monument is configured to be disposed in front of a first-row business class passenger seat and is structurally separate from the passenger seat;
the privacy wall and ottoman define an open, unobstructed footwell extending between the passenger seat and the monument without enclosing walls;
the ottoman defines a stowage space beneath a foot support surface;
the ottoman is disposed opposite the passenger seat; and
the monitor is disposed in a wall of the monument opposite the passenger seat;
the ottoman is configured to support a second passenger seated on the ottoman facing the passenger seat;
the ottoman includes integrated seatbelt features for restraining the second passenger while seated on the ottoman; and
the ottoman includes attachment features configured to secure a bassinet to the ottoman.

16. (canceled)

17. The aircraft of claim 15, further comprising a stowable tray table disposed for use by the second passenger when the second passenger uses the ottoman as a seat.

18. (canceled)

19. The aircraft of claim 15, further comprising a cushioned backrest portion disposed along at least one internal wall of the monument, proximal to the ottoman.

20. The aircraft of claim 15, wherein the ottoman is configured to abut an edge of the passenger seat when the passenger seat is in a reclined configuration.
